(19) United States
(12) Patent Application Publication
(10) Pub. No.: US 2005/0253759 A1
(43) Pub. Date: Nov. 17, 2005

(54) Inverted-F antenna having reinforced fixing structure

(75) Inventors: I-Ru Liu, Taipei City (TW); Po-Kang Wang, Hsinchu City (TW); Hong-Kun Tyan, Taoyuan Hsien (TW)

Correspondence Address: DENNISON, SCHULTZ, DOUGHERTY & MACDONALD, 1727 KING STREET, SUITE 105, ALEXANDRIA, VA, 22314, US

(73) Assignee: Arcadyan Technology Corporation

(21) Appl. No.: 11/121,030

(22) Filed: May 4, 2005

(30) Foreign Application Priority Data
May 12, 2004 (TW) 93113363

(51) Int. Cl. H01Q 1/24

(52) U.S. Cl. 343/702; 343/878

(57) ABSTRACT

An inverted-F antenna having a reinforced fixing structure is disclosed for benefiting antenna diversity. The inverted-F antenna is composed of a base board (such as a printed circuit board), a radiator and at least one supporting member each having a beveled fixing foot, wherein the shape of the radiator can be changed in accordance with various bending directions, such as a L shape, a U shape or a Z shape. The reinforced fixing structure of the inverted-F antenna further includes a dielectric material (such as foam adhesive) used for partially filling in the gap between the radiator and the base board, thereby reinforcing the strength of fixing each supporting member to the base board.

### RELATED APPLICATIONS

The present application is based on, and claims priority from, Taiwan Application Serial Number 93113363, filed May 12, 2004, the disclosure of which is hereby incorporated by reference herein in its entirety.

### FIELD OF THE INVENTION

The present invention relates to an inverted-F antenna, and more particularly, to the inverted-F antenna which has a reinforced fixing structure and is advantageous to the arrangement of antenna diversity.

### BACKGROUND OF THE INVENTION

With the advancement of communication technologies, the communication technologies are increasingly applied in high-tech products, so that communication products become more diversified. Recently, since consumers have increasingly high function requirements for communication products, various communication products and technologies have been continuously appearing in the market, wherein the computer network products with wireless communication functions are the main streams recently. Moreover, with integrated circuit (IC) technologies getting matured, the size of product has been gradually developed toward smallness, thinness, shortness and lightness.

In a communication product, an antenna playing the role of transmitting and receiving signals is very important in research and design, especially printed antennas or low-profiled antennas. The antenna is an element used for radiating or receiving electromagnetic wave, and generally, the features of antenna can be known by the parameters of operation frequency, radiation patterns, reflected loss, and antenna gain, etc.

According to different operation requirements, the functions equipped in the communication products are not all the same, and thus there are many varieties of antenna designs used for radiating or receiving signals, such as a rhombic antenna, a turnstile antenna, a triangular microstrip antenna, and an inverted-F antenna, etc. The structure of a conventional inverted-F antenna basically includes a small piece of metal plate installed on a ground plane to be a radiating main body, and a short line that is added on the edge of the radiating main body and connected to the ground plane, so that the length of antenna is reduced from ½ resonance wavelength (λ) to ¼ resonance wavelength, thus achieving the effect of miniaturizing the antenna size.

Referring to FIG. 1, FIG. 1 is a 3-D schematic diagram showing a conventional inverted-F antenna. Such as shown in FIG. 1, the conventional inverted-F antenna is composed of a ground plate 10 (base board), a radiating metal plate 40, a short plate 42 and a TEM transmission line 30, wherein one end of the short plate 42 is vertically connected to one end of the radiating metal plate 40, and the other end of the short plate 42 is vertically connected to the ground plate 10. The TEM transmission line 30 is composed of an inner conductor 34 and an outer conductor 32, wherein the inner conductor 34 is vertically connected to the radiating metal plate 40 for feeding signals. The conventional inverted-F antenna is formed three-dimensionally by using the short plate 42, the TEM transmission line 30 (a feed line) or both as supporting members for fixing the radiating metal plate 40 on the ground plate 10. However, the conventional inverted-F antenna cannot be firmly fixed to the base board merely by inserting one end of the supporting member directly into the base board. For firmly securing the antenna to the base board, one conventional skill folds one end of the supporting member as a L shape, and the L-shaped end is disposed and soldered on the base board. The structure used in this conventional skill is quite complicated, and the shape of the L-shaped end is changed after the welding area is expanded, thus affecting the electrical stability. The other conventional skill uses hard material such as acrylic as a medium filled between the base board and the radiating metal plate 40 for assisting the fixing of the inverted-F antenna. However, this conventional skill has the disadvantage of high material cost.

On the other hand, the radiating metal plate 40 generally is a straight strip. For the products emphasizing on miniaturization, it is quite difficult to further shorten the radiating metal plate 40 of straight strip, thus causing quite a big design difficult.

Hence, there is an urgent need to develop an inverted-F antenna having a reinforced fixing structure for satisfactorily meeting the antenna requirements of small size, high gain, broad bandwidth, simple design, and low cost, etc., thereby further reducing the main body length of the conventional inverted-F antenna and reinforcedly fixing the inverted-F antenna on the base board.

### SUMMARY OF THE INVENTION

An aspect of the present invention is to provide an inverted-F antenna having a reinforced fixing structure, thereby reducing the main body length of antenna, lowering fabrication cost, and benefiting the arrangement of antenna diversity.

The other aspect of the present invention is to provide an inverted-F antenna having a reinforced fixing structure, thereby effectively providing reinforcement for fixing the inverted-F antenna on a base board; and lowering material cost.

According to the aforementioned aspects, the present invention provides an inverted-F antenna having a reinforced fixing structure. According to a preferred embodiment of the present invention, the inverted-F antenna comprises a base board and a radiator body and at least one supporting member. The base board has a first surface and a second surface, wherein the first surface is parallel to the second surface. The radiator body is located above the first surface of the base board, wherein the radiator body is spaced from the first surface with a distance. The radiator body comprises an elongate radiator and a first extending radiator, wherein the first extending radiator is electrically connected to one end of the elongate radiator with an angle substantially equal to 90 degrees (i.e. vertically). One end of each supporting member is inserted into the first surface, and the other end of each supporting member is electrically connected to at least one position on the radiator body. The aforementioned one end of each supporting member has a beveled fixing foot.

The radiator body further comprises a second extending radiator, wherein the second extending radiator is electrically connected to the other end of the elongate radiator with an angle substantially equal to 90 degrees (i.e. vertically). The first extending radiator and the second extending radiator are located on the same side or two opposite sides of the elongate radiator.

The inverted-F antenna further comprises a ground plane, wherein the ground plane is located on the base board.

Hence, with the use of the present invention, a feed line having a beveled fixing foot and a short line having a beveled fixing foot both can be used in combination with local foam adhesive or hard and thick material to effectively provide reinforcement for fixing the inverted-F antenna on the base board and to lower material cost; the geometrical shape of various folded radiators can be used to greatly reducing the main body length of the inverted-F antenna, thus benefiting the arrangement of antenna diversity.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

The foregoing aspects and many of the attendant advantages of this invention will become more readily appreciated as the same becomes better understood by reference to the following detailed description, when taken in conjunction with the accompanying drawings, wherein:

FIG. 1 is a 3-D schematic diagram showing a conventional inverted-F antenna;

FIG. 2A and FIG. 2B are schematic side views respectively showing the inverted-F antennas of the present invention with different types of beveled fixing foot;

FIG. 3A is a schematic top view of an inverted-F antenna having a reinforced fixing structure according to a first preferred embodiment of the present invention;

FIG. 3B is a schematic top view of an inverted-F antenna having a reinforced fixing structure according to a second preferred embodiment of the present invention;

FIG. 3C is a schematic top view of an inverted-F antenna having a reinforced fixing structure according to a third preferred embodiment of the present invention;

FIG. 4A is a diagram showing a measured curve of SWR (Standing Wave Ratio) vs. frequency for the inverted-F antenna of the first preferred embodiment of the present invention;

FIG. 4B is a diagram showing a measured curve of SWR vs. frequency for the inverted-F antenna of the second preferred embodiment of the present invention;

FIG. 4C is a diagram showing a measured curve of SWR vs. frequency for the inverted-F antenna of the third preferred embodiment of the present invention;

FIG. 5A is a diagram showing an elevation radiation pattern when the inverted-F antenna of the first preferred embodiment is operated at 2.45 GHz, wherein (φ=0°;

FIG. 5B is a diagram showing an elevation radiation pattern when the inverted-F antenna of the first preferred embodiment is operated at 2.45 GHz, wherein φ=90°;

FIG. 5C is a diagram showing an azimuth radiation pattern when the inverted-F antenna of the first preferred embodiment is operated at 2.45 GHz, wherein θ=0°;

FIG. 6A is a diagram showing an elevation radiation pattern when the inverted-F antenna of the second preferred embodiment is operated at 2.44 GHz, wherein φ=0°;

FIG. 6B is a diagram showing an elevation radiation pattern when the inverted-F antenna of the second preferred embodiment is operated at 2.44 GHz, wherein φ=90°;

FIG. 6C is a diagram showing an azimuth radiation pattern when the inverted-F antenna of the second preferred embodiment is operated at 2.44 GHz, wherein θ=0°;

FIG. 7A is a diagram showing an elevation radiation pattern when the inverted-F antenna of the third preferred embodiment is operated at 2.45 GHz, wherein φ=0°;

FIG. 7B is a diagram showing an elevation radiation pattern when the inverted-F antenna of the third preferred embodiment is operated at 2.45 GHz, wherein φ=90°; and

FIG. 7C is a diagram showing an azimuth radiation pattern when the inverted-F antenna of the third preferred embodiment is operated at 2.45 GHz, wherein θ=0°.

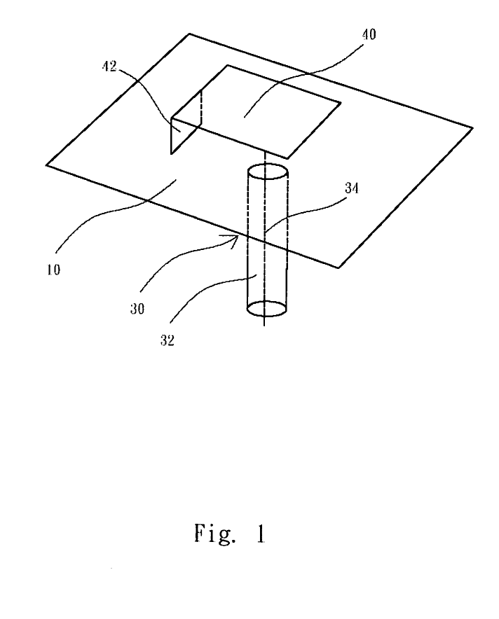

### DETAILED DESCRIPTION OF THE PREFERRED EMBODIMENT

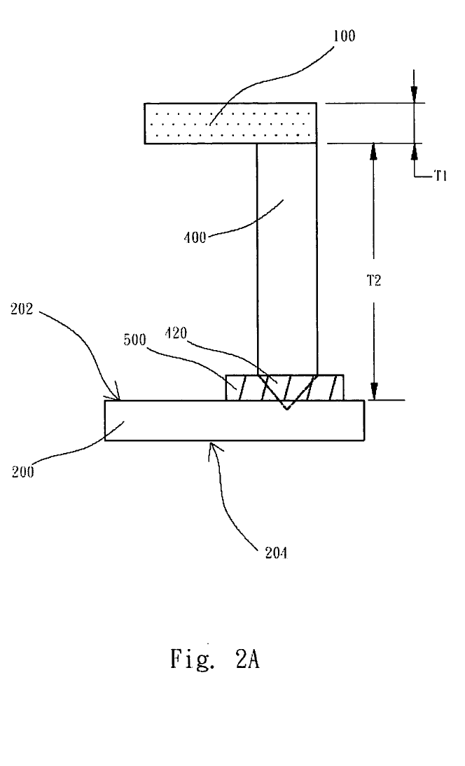

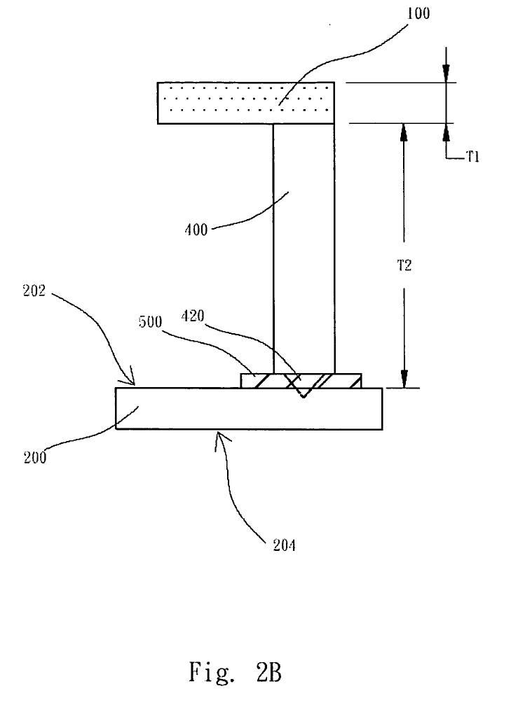

Referring to FIG. 2A and FIG. 2B, FIG. 2A and FIG. 2B are schematic side views respectively showing the inverted-F antennas of the present invention with different types of beveled fixing foot. A base board 200 (for example: a printed circuit board) has a first surface 202 and a second surface 204, and the first surface 202 is parallel to the second surface 204. A radiator body 100 (for example: a rectangle) is installed on the first surface 202 of the base board 200 via at least one supporting member 400, and is spaced from the first surface 202 with a distance T2 (i.e. the length of the supporting member 400). A ground plane (not shown) can be formed on the first surface 202 or the second surface 204. The base board 200 can be a printed circuit board made of glass fiber material (such as FR4) or other materials, and the radiator body 100 and the ground plane can be made of metal material.

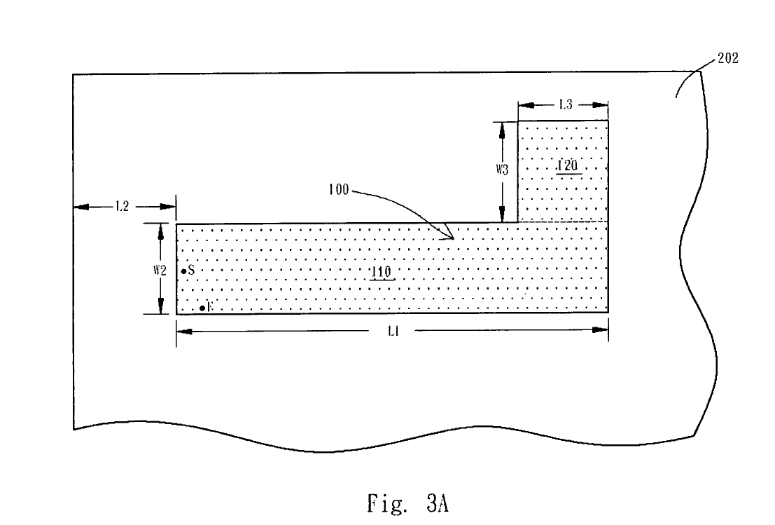

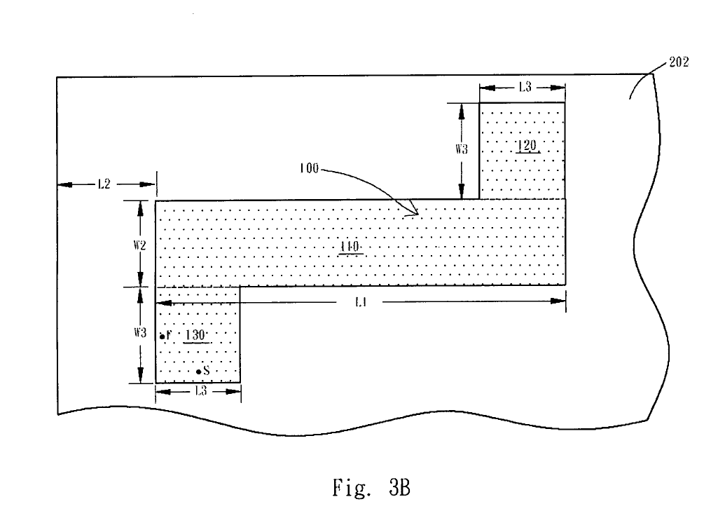

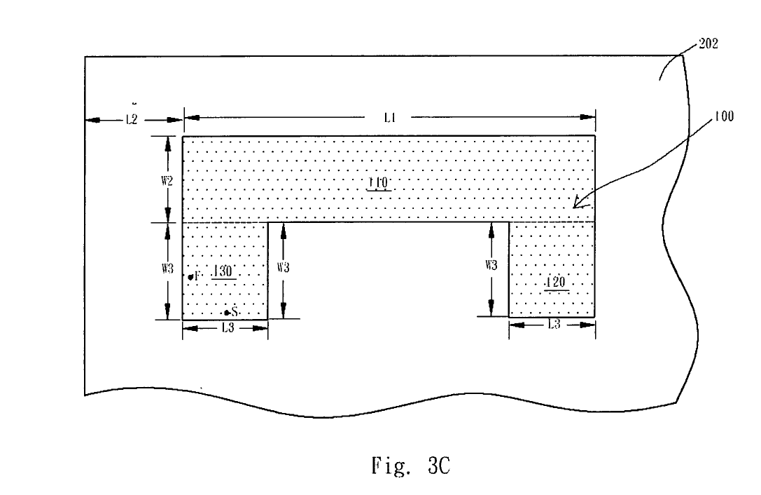

One end of the supporting member 400 is inserted into the first surface 202, and the other end of the supporting member 400 is electrically connected to a position located on the radiator body 100. In accordance with the actual needs, the supporting member 400 can be one of a short line and a feed line, or both the short line and the feed line can be used as the supporting members 400 (i.e. there are two supporting members 400). If the supporting member 400 is the short line, then the position on the radiator body 100 connected the supporting member 400 is the so-called short point (such as the shot point S shown in FIG. 3A). If the supporting member 400 is the feed line, then the position on the radiator body 100 connected the supporting member 400 is the so-called feed point (such as the feed point F shown in FIG. 3A). If the supporting members 400 are both the short line and the feed line, then the positions on the radiator body 100 connected the supporting member 400 are corresponding to the short point and the feed point respectively. A dielectric material 500 (such as foam adhesive or hard and thick material) is used for filling in at least one part of the gap between the radiator body 100 and the base board 200, so as to provide reinforcement for fixing the supporting member 400 on the base board 200.

The end of the supporting member 400 inserted into the first plane 202 has a beveled fixing foot 420. The present invention is featured in inserting the sharp tip of the beveled fixing foot 420 into the base board 200, thereby enhancing the fixing force via a larger contact area between the base board 200 and the slope of the beveled fixing foot 420. The beveled fixing foot 420 of the present invention can be formed in various types. For example, one end of the beveled fixing foot 420 can cover the entire surface of the connection end of the supporting member 400 (such as shown in FIG. 2A), or can merely cover a partial surface thereof (such as shown in FIG. 2B). On the other hand, the length of the beveled fixing foot 420 also can have several variations. For example, the length of the beveled fixing foot 420 can be equal to the length of the supporting member 400, i.e. the entire supporting member is actually the beveled fixing foot 420.

The feeding method of the present invention can be the method of connecting the feed point F to the ground plane located on the first surface 202 by using an elongate pin (such as the supporting member 400); or that of connecting the feed point F to a coplanar waveguide (CPW) located on the second surface 204 by using an elongate pin (such as the supporting member 400), etc.

Further, such as shown in FIG. 2A or FIG. 2B, the thickness T1 of the radiator body 100 is about between 0.2 mm and 0.43 mm, and the distance T2 is about between 2.5 mm and 6.5 mm.

Referring to FIG. 3A to FIG. 3C, FIG. 3A is a schematic top view of an inverted-F antenna having a reinforced fixing structure according to a first preferred embodiment of the present invention; FIG. 3B is a schematic top view of an inverted-F antenna having a reinforced fixing structure according to a second preferred embodiment of the present invention; and FIG. 3C is a schematic top view of an inverted-F antenna having a reinforced fixing structure according to a third preferred embodiment of the present invention. The radiator body 100 can be varied in shape as follows:

Such as shown in FIG. 3A, according to the first preferred embodiment of the present invention, the radiator body 100 is composed of an elongate radiator 110 (such as a rectangle) and a extending radiator 120 (such as a rectangle), wherein the extending radiator 120 is electrically connected to one end (left end) of the elongate radiator 110 with an angle substantially greater than 0 degree (such as 90 degrees), so as to form a reversed-L shape (such as shown in FIG. 3A). However, the elongate radiator 110 and the extending radiator 120 also can be combined to form a right-L shape. The length L1 of the elongate radiator 110 is between about 17 mm and 27 mm, and the width W2 thereof is between about 3 mm and 7 mm. The distance L2 between the other end (right end) of the elongate radiator 110 not connected to the extending radiator 120, and the adjacent side of the surface is between about 7 mm and 13 mm. The length L3 of the extending radiator 120 is between about 3 mm and 7 mm, and the width W3 thereof is between about 3.5 mm and 5.5 mm. The short point S is adjacent to the right end of the elongate radiator 110, and the distance between the short point S and the longer side (lower side) of the elongate radiator 110 is between about 0.35W2 and 0.65W2. The feed point F is adjacent to the lower side of the elongate radiator 110, and the distance between the feed point F and the left side of the elongate radiator 110 is between about 0.35W2 and 0.65W2.

Such as shown in FIG. 3B, according to the second preferred embodiment of the present invention, the radiator body 100 is composed of an elongate radiator 110 (such as a rectangle), a extending radiator 120 and a extending radiator 130 (such as a rectangle), wherein the extending radiator 120 and the extending radiator 130 are electrically connected to two opposite ends of the elongate radiator 110 respectively with angles substantially greater than 0 degree (such as 90 degrees), and the extending radiator 120 and the extending radiator 130 are located on two opposite sides of the elongate radiator 110 respectively, thereby forming a Z shape (such as shown in FIG. 3B). The length L1 of the elongate radiator 110 is between about 17 mm and 25 mm, and the width W2 thereof is between about 3 mm and 7 mm. The distance L2 between the other end (right end) of the elongate radiator 110 connected to the extending radiator 130, and the adjacent side of the surface is between about 7 mm and 13 mm. The length L3 of the extending radiator 120 or the extending radiator 130 is between about 3 mm and 7 mm, and the width W3 thereof is between about 3.5 mm and 5.5 mm. The feed point F is located on the right side of the extending radiator 130, and the distance between the feed point F and the lower side of the extending radiator 130 is between about 0.35L3 and 0.65L3. The short point S is adjacent to the lower side of the extending radiator 130, and the distance between the short point S and the left side of the extending radiator 130 is between about 0.35L3 and 0.65L3.

Such as shown in FIG. 3C, according to the third preferred embodiment of the present invention, the extending radiator 120 and the extending radiator 130 are electrically connected to two opposite ends of the elongate radiator 110 respectively with angles substantially greater than 0 degree (such as 90 degrees), and the extending radiator 120 and the extending radiator 130 are located on the same side of the elongate radiator 110 respectively, thereby forming a U shape (such as shown in FIG. 3C). The length L1 of the elongate radiator 110 is between about 16.5 mm and 25.5 mm, and the width W2 thereof is between about 3 mm and 7 mm. The distance L2 between the other end (right end) of the elongate radiator 110 connected to the extending radiator 130, and the adjacent side of the surface is between about 7 mm and 13 mm. The length L3 of the extending radiator 120 or the extending radiator 130 is between about 3 mm and 7 mm, and the width W3 thereof is between about 3.5 mm and 5.5 mm. The feed point F is located on the right side of the extending radiator 130, and the distance between the feed point F and the lower side of the extending radiator 130 is between about 0.35L3 and 0.65L3. The short point S is adjacent to the lower side of the extending radiator 130, and the distance between the short point S and the right side of the extending radiator 130 is between about 0.35L3 and 0.65L3.

It can be known from the aforementioned specification, the inverted-F antenna of the present invention has the advantages of small size and low fabrication cost.

The shapes (elongate shapes) and connecting positions of the elongate radiator 110, the extending radiator 120 and the extending radiator 130; the short point F and feeding point F, and the size and shape of the antenna described above are merely stated as examples for explanation, and the present invention is not limited thereto. For example, the elongate radiator 110, the extending radiator 120 and the extending radiator 130 can also be formed in arc-line shapes or cut-cornered rectangles.

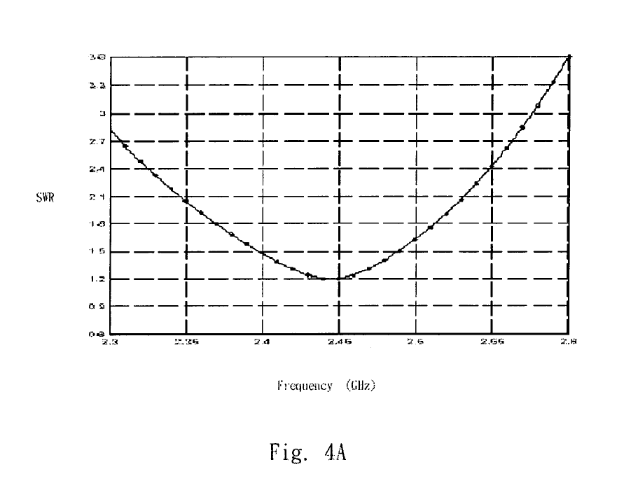

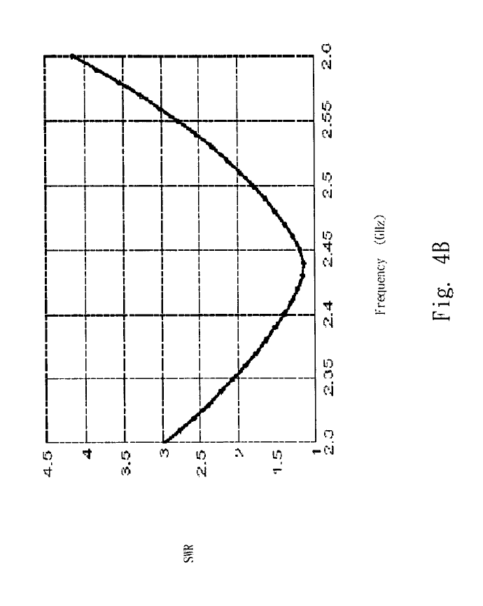

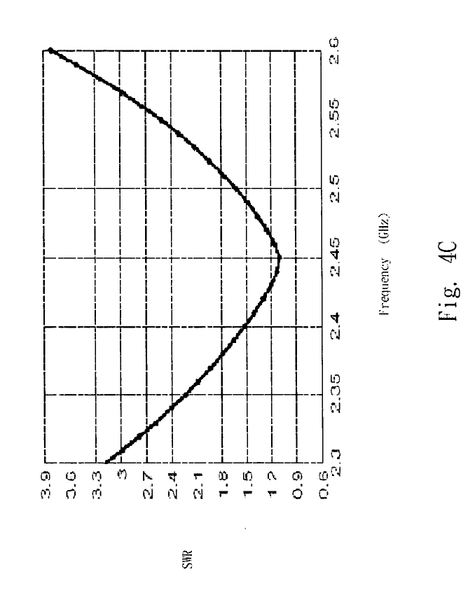

Moreover, the inverted-F antenna of the present invention has quite excellent antenna features. Referring to FIG. 4A, FIG. 4A is a diagram showing a measured curve of SWR (Standing Wave Ratio) vs. frequency for the inverted-F antenna of the first preferred embodiment of the present invention. When the inverted-F antenna of the first preferred embodiment is operated at about 2.45 GHz, the SWR is about 1:1.2. With the reference SWR of about 1:1.8 and the central frequency of about 2.45 GHz, the inverted-F antenna of the first preferred embodiment can provide the bandwidth of about 150 MHz, thus having an excellent antenna feature of bandwidth. Further, referring to FIG. 4B, FIG. 4B is a diagram showing a measured curve of SWR vs. frequency for the inverted-F antenna of the second preferred embodiment of the present invention. When the inverted-F antenna of the second preferred embodiment is operated at about 2.44 GHz, the SWR is about 1:1.149. With the reference SWR of about 1:1.8 and the central frequency of about 2.44 GHz, the inverted-F antenna of the second preferred embodiment can provide the bandwidth of about 130 MHz, thus having an excellent antenna feature of bandwidth. Further, referring to FIG. 4C, FIG. 4C is a diagram showing a measured curve of SWR vs. frequency for the inverted-F antenna of the third preferred embodiment of the present invention. When the inverted-F antenna of the third preferred embodiment is operated at about 2.45 GHz, the SWR is about 1:1.117. With the reference SWR of about 1:1.8 and the central frequency of about 2.45 GHz, the inverted-F antenna of the third preferred embodiment can provide the bandwidth of about 140 MHz, thus having an excellent antenna feature of bandwidth.

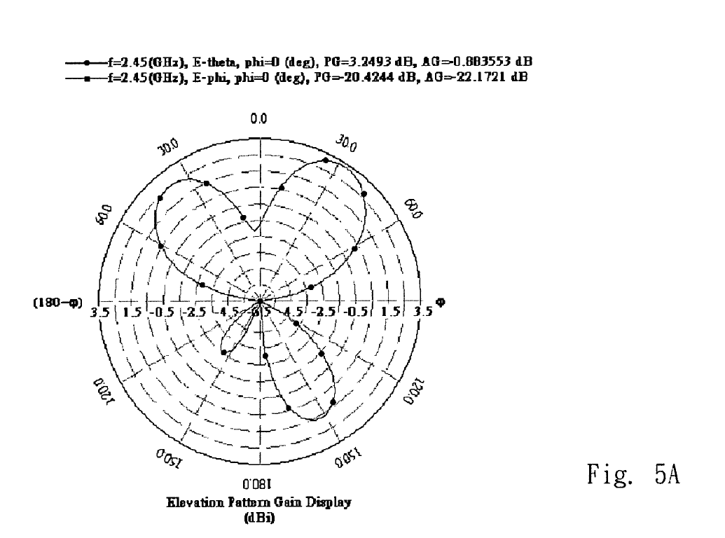

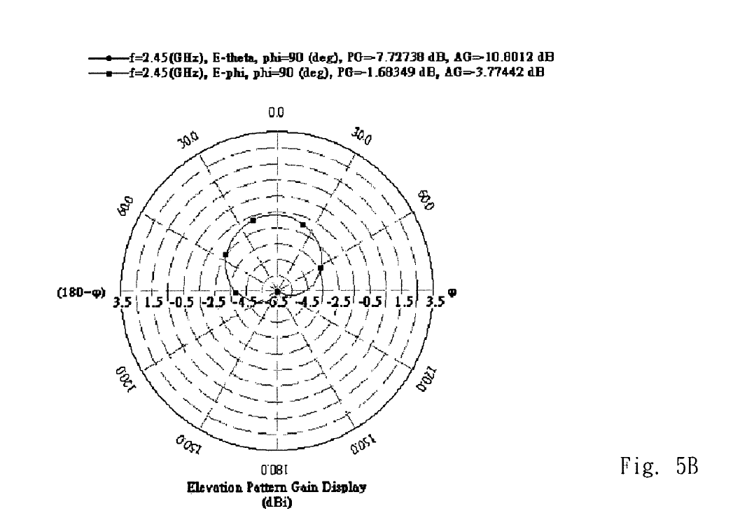

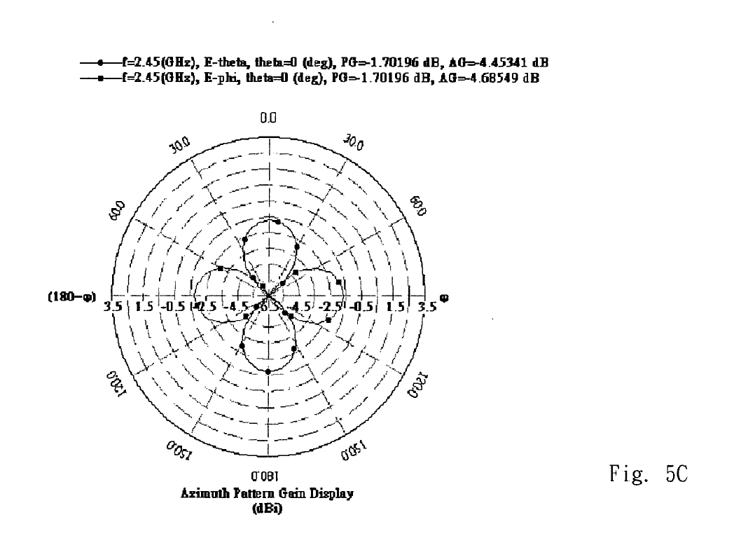

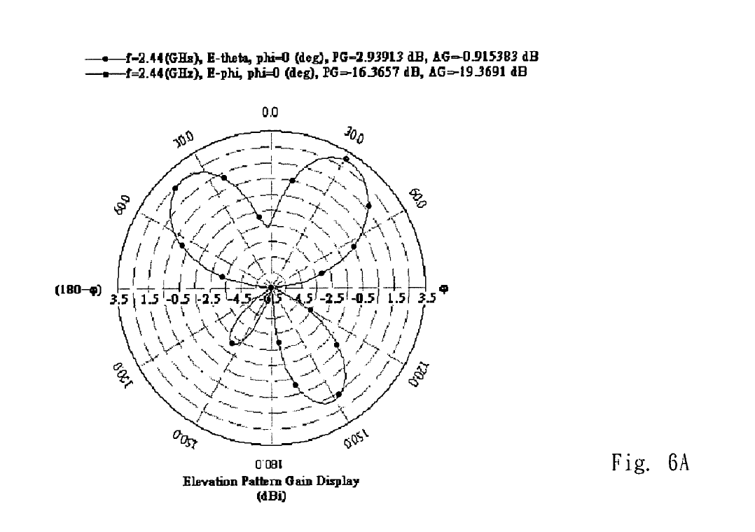

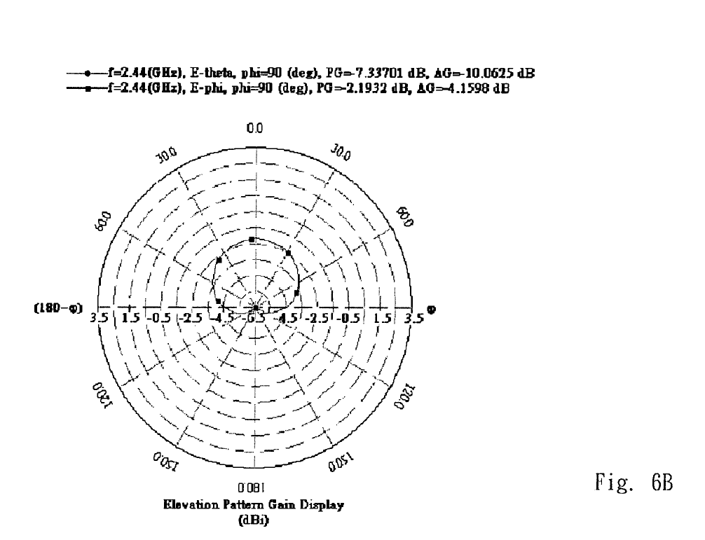

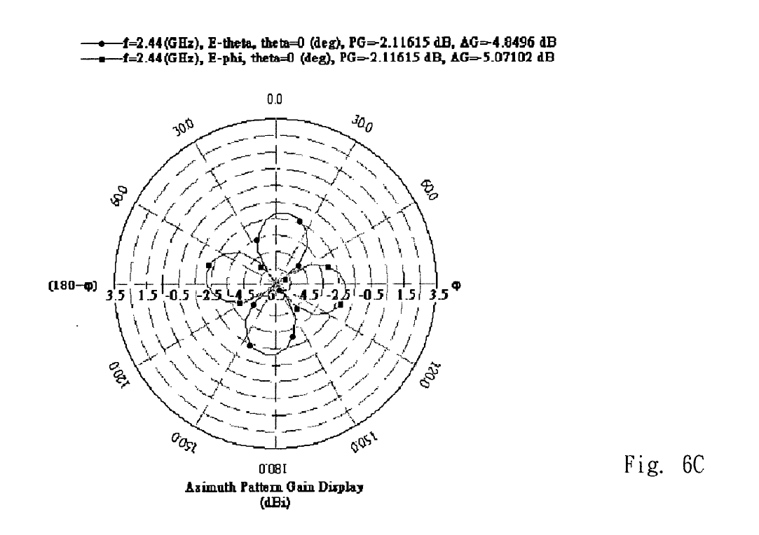

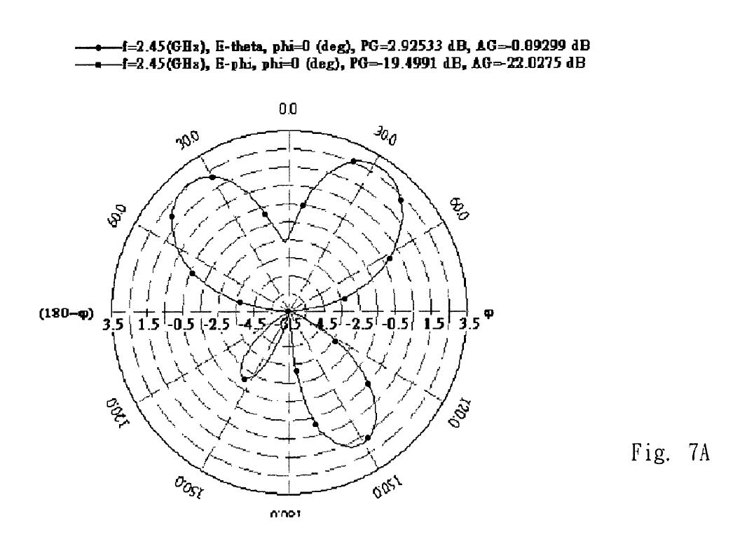

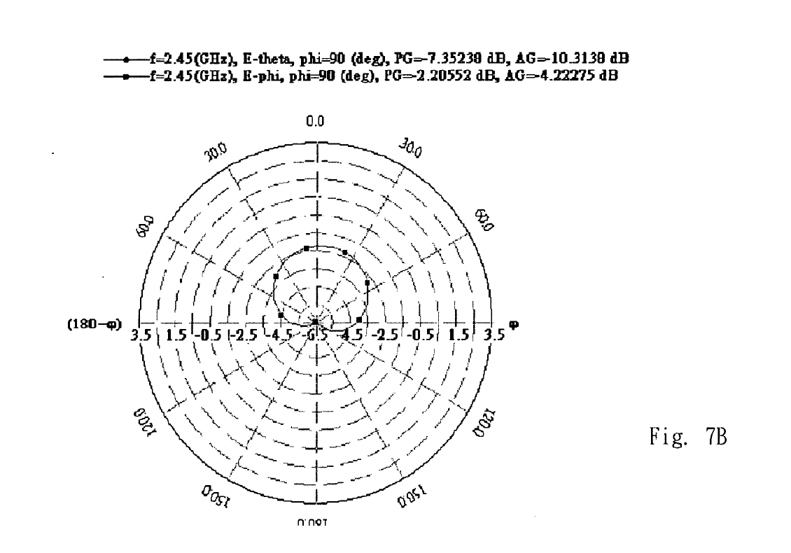

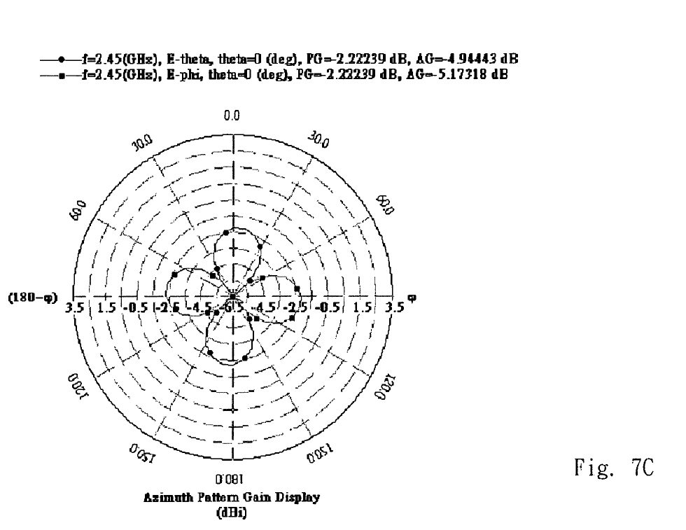

Referring to FIG. 5A to FIG. 5C, FIG. 5A is a diagram showing an elevation radiation pattern when the inverted-F antenna of the first preferred embodiment is operated at 2.45 GHz, wherein φ=0°; FIG. 5B is a diagram showing an elevation radiation pattern when the inverted-F antenna of the first preferred embodiment is operated at 2.45 GHz, wherein φ=90°; and FIG. 5C is a diagram showing an azimuth radiation pattern when the inverted-F antenna of the first preferred embodiment is operated at 2.45 GHz, wherein θ=0°. Accordingly, it can be known from FIG. 5A to FIG. 5C that the inverted-F antenna of the first preferred embodiment demonstrates excellent radiation patterns, thus sufficiently satisfying user requirements. Further, referring to FIG. 6A to FIG. 6C, FIG. 6A is a diagram showing an elevation radiation pattern when the inverted-F antenna of the second preferred embodiment is operated at 2.44 GHz, wherein φ=0°; FIG. 6B is a diagram showing an elevation radiation pattern when the inverted-F antenna of the second preferred embodiment is operated at 2.44 GHz, wherein φ=90°; and FIG. 6C is a diagram showing an azimuth radiation pattern when the inverted-F antenna of the second preferred embodiment is operated at 2.44 GHz, wherein θ=0°. Accordingly, it can be known from FIG. 6A to FIG. 6C that the inverted-F antenna of the second preferred embodiment demonstrates excellent radiation patterns, thus sufficiently satisfying user requirements. Further, referring to FIG. 7A to FIG. 7C, FIG. 7A is a diagram showing an elevation radiation pattern when the inverted-F antenna of the third preferred embodiment is operated at 2.45 GHz, wherein θ=0°; FIG. 7B is a diagram showing an elevation radiation pattern when the inverted-F antenna of the third preferred embodiment is operated at 2.45 GHz, wherein φ=90°; and FIG. 7C is a diagram showing an azimuth radiation pattern when the inverted-F antenna of the third preferred embodiment is operated at 2.45 GHz, wherein θ=0°. Accordingly, it can be known from FIG. 7A to FIG. 7C that the inverted-F antenna of the third preferred embodiment demonstrates excellent radiation patterns, thus sufficiently satisfying user requirements.

Just as described in the aforementioned preferred embodiments of the present invention, the application of the present invention has the advantages of using air as medium and the combination of the feed line and short line having beveled fixing feet with local foam adhesive or hard and thick material to effectively provide reinforcement for fixing the inverted-F antenna on the base board; low material cost; using the geometrical shape of various folded radiators to greatly reducing the main body length of the inverted-F antenna, thus benefiting the arrangement of antenna diversity.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

1. An inverted-F antenna having a reinforced fixing structure, said inverted-F antenna comprising:
a base board, having a first surface and a second surface, wherein said first surface is parallel to said second surface;
a radiator body located above said first surface of said base board, wherein said radiator body is spaced from said first surface with a distance, said radiator body comprising an elongate radiator; and
at least one supporting member, wherein one end of each of said at least one supporting member is inserted into said first surface, and the other end of each of said at least one supporting member is electrically connected to at least one position on said radiator body, said one end of each of said at least one supporting member having a beveled fixing foot.

2. The inverted-F antenna of claim 1, wherein one end of said beveled fixing foot covers a partial surface of said one end of each of said at least one supporting member.

3. The inverted-F antenna of claim 1, wherein one end of said beveled fixing foot covers the entire surface of said one end of each of said at least one supporting member.

4. The inverted-F antenna of claim 1, wherein the length of said beveled fixing foot is substantially equal to the length of each of said at least one supporting member.

5. The inverted-F antenna of claim 1, further comprising:
a dielectric material used for filling at least one part of the gap between said radiator body and said base board, thereby reinforcing the fixing of each of said at least one supporting member to said base board.

6. The inverted-F antenna of claim 5, wherein said dielectric material is foam adhesive.

7. The inverted-F antenna of claim 1, wherein each of said at least one supporting members is a short line, and said at least one position on said radiator body is a short point.

8. The inverted-F antenna of claim 1, wherein each of said at least one supporting members is a feed line, and said at least one position on said radiator body is a feed point.

9. The inverted-F antenna of claim 1, wherein said at least one supporting member includes a short line and a feed line, and said at least one position on said radiator body includes a short point and a feed point.

10. The inverted-F antenna of claim 1, wherein said radiator body further comprises:
a first extending radiator electrically connected to one end of said elongate radiator with an angle greater than 0 degree.

11. The inverted-F antenna of claim 10, wherein said first extending radiator is substantially vertical to said one end of said elongate radiator

12. The inverted-F antenna of claim 10, wherein said radiator body further comprises:
a second extending radiator electrically connected to the other end of said elongate radiator with an angle greater than 0 degree.

13. The inverted-F antenna of claim 12, wherein said second extending radiator is substantially vertical to the other end of said elongate radiator.

14. The inverted-F antenna of claim 13, wherein said first extending radiator and said second extending radiator are located on the same side of said elongate radiator.

15. The inverted-F antenna of claim 13, wherein said first extending radiator and said second extending radiator are located on two opposite sides of said elongate radiator.

16. The inverted-F antenna of claim 1, wherein said base board is a printed circuit board.

17. An inverted-F antenna having a reinforced fixing structure, said inverted-F antenna comprising:
a base board, having a first surface and a second surface, wherein said first surface is parallel to said second surface;
a radiator body located above said first surface of said base board, wherein said radiator body is spaced from said first surface with a distance, said radiator body comprising:
an elongate radiator; and
a first extending radiator electrically connected to one end of said elongate radiator with an angle substantially equal to 90 degrees; and
at least one supporting member, wherein one end of each of said at least one supporting member is inserted into said first surface, and the other end of each of said at least one supporting member is electrically connected to at least one position on said radiator body, said one end of each of said at least one supporting member having a beveled fixing foot.

18. The inverted-F antenna of claim 17, further comprising:
a dielectric material used for filling at least one part of the gap between said radiator body and said base board, thereby reinforcing the fixing of each of said at least one supporting member to said base board.

19. The inverted-F antenna of claim 17, wherein said radiator body further comprises:
a second extending radiator electrically connected to the other end of said elongate radiator with an angle substantially equal to 90 degrees, wherein said first extending radiator and said second extending radiator are located on the same side of said elongate radiator.

20. The inverted-F antenna of claim 17, wherein said radiator body further comprises:
a second extending radiator electrically connected to the other end of said elongate radiator with an angle substantially equal to 90 degrees, wherein said first extending radiator and said second extending radiator are located on two opposite sides of said elongate radiator.
